(19) United States
(12) Patent Application Publication
(10) Pub. No.: US 2007/0083472 A1
(43) Pub. Date: Apr. 12, 2007

(54) Customer Satisfaction Reporting

(76) Inventor: Max Lewis Israel, Seattle, WA (US)

Correspondence Address: WHITAKER LAW GROUP, 755 WINSLOW WAY EAST, SUITE 304, BAINBRIDGE ISLAND, WA, 98110, US

(21) Appl. No.: 11/539,413

(22) Filed: Oct. 6, 2006

Related U.S. Application Data
(60) Provisional application No. 60/724,336, filed on Oct. 6, 2005.

(51) Int. Cl. G06Q 99/00

(52) U.S. Cl. 705/55

(57) ABSTRACT

A system enables a customer to participate in a survey or otherwise answer questions about the customer's experience with a business. The system aggregates the responses of many customers and provides a reporting mechanism. A client, such as a representative of the business, can interact with the reporting mechanism to discern customer satisfaction. The system may allow the customer to provide free form text during the survey process. If the system detects an anomalous occurrence, such as the presence of a key word, that occurrence is immediately communicated to a designee of the business.

### BACKGROUND

Customer satisfaction is enormously important to most businesses. Most companies at least strive for high customer satisfaction and many take active steps to measure it. For example, most restaurants make comment cards readily available to their patrons to invite customer feedback. Many companies, particularly service-based companies, actively solicit customer feedback, such as through follow up calls or surveys. Some companies even hire individuals as pretend customers of the companies' stores to evaluate the customer experience first hand. These and many other techniques are employed for measuring customer satisfaction. However, advances in the realm of customer satisfaction surveys are always welcome in the business world.

### SUMMARY

The present invention is directed at measuring and/or reporting customer satisfaction. Generally stated, a system enables a customer to participate in a survey or otherwise answer questions about the customer's experience with a business. The system aggregates the responses of many customers and provides a reporting mechanism. A client, such as a representative of the business, can interact with the reporting mechanism to discern customer satisfaction.

In one particular aspect, the system allows the customer to provide free form text during the survey process. If the system detects an anomalous occurrence, that occurrence is immediately communicated to a designee of the business. In one example, the anomalous occurrence may be that the customer entered one or more key words that have been identified as critical to the business. In such a case, when the customer entered the key word(s), the system immediately transmits a notice to the designee of the business so that the occurrence can be addressed.

### BRIEF DESCRIPTION OF THE DRAWINGS

FIG. 1 is a functional block diagram generally illustrating a system for measuring and/or reporting customer satisfaction.

FIG. 2 is a functional block diagram illustrating in greater detail the survey provider introduced in conjunction with FIG. 1.

FIGS. 3-5 are graphical illustrations of screen displays that may be presented using the system introduced in conjunction with FIG. 1.

FIG. 6 is an operational flow diagram generally illustrating steps performed by a process for measuring and/or reporting customer satisfaction.

### DETAILED DESCRIPTION OF THE DRAWINGS

Generally stated, the invention is directed at customer satisfaction. In one embodiment, a system allows customers of a business to participate in a survey about their experiences with the business. The survey results are available for inspection by representatives of the business online. In certain cases, critical information may be provided by a customer participating in the survey. In such a case, notice of that critical information is immediately communicated to the business or to a designee of the business.

The components illustrated in the figures are functional in nature, and may or may not directly correspond to physical manifestations in actual embodiments. In other words, components illustrated and described as a single computing component may in actuality be implemented as a single component or, alternatively, as components distributed over multiple computing systems. And conversely, functionality illustrated as distributed over multiple components in these embodiments could in actuality be implemented on a single computing system.

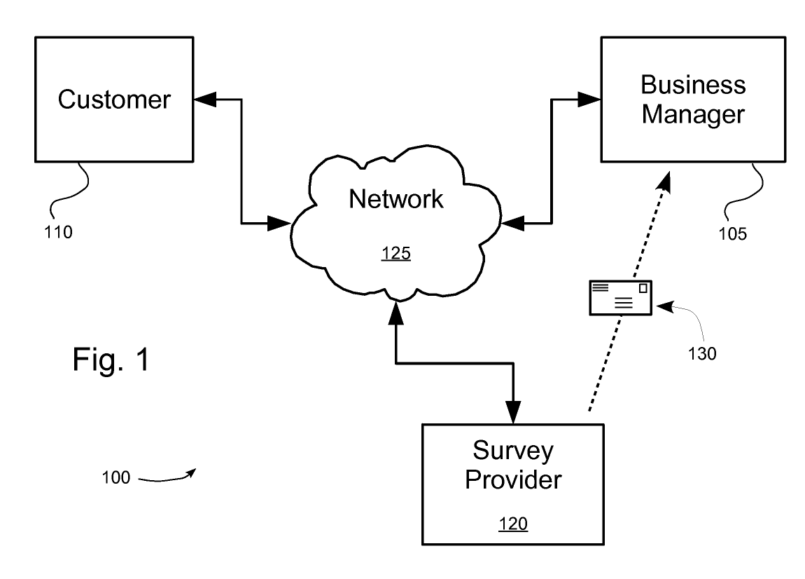

FIG. 1 is a functional block diagram generally illustrating a system 100 for measuring and/or reporting customer satisfaction. As illustrated in FIG. 1, the system 100 includes a business manager computer system 105, a customer computer system 110, and a survey provider computer system 120. In this embodiment, each of the computing systems communicate with each other over a network 125, such as the Internet. As described more fully below, the system 100 enables a customer to provide feedback to a business through a survey provider. In addition, if the customer provides feedback that has been deemed critical, the survey provider immediately notifies the business.

The business manager 105 represents a computer system operated by a business enterprise, non-profit organization, government agency, or other entity that provides goods and/or services to consumers. The business manager 105 may be implemented as any conventional computing system and includes browsing software for retrieving and communicating with other computers over a network. In this implementation, the business manager 105 is used by a designee of the business enterprise to monitor customer satisfaction information, such as using the browsing software over the Internet. The business manager 105 may also include messaging components for receiving electronic messages, such as e-mail, instant messages, electronic faxes, or the like.

The customer 110 represents a computer system operated by an individual or other entity that has done business with the enterprise, or for some other reason has feedback information about the enterprise. In one embodiment, the customer 110 includes browsing software that enables access to web pages or the like over a network. In other embodiments, the customer 110 includes messaging software, such as e-mail or instant messaging software, operative to transmit and/or receive electronic messages. In still other embodiments, the customer 110 could be a human being who provides his or her feedback orally (e.g., by telephone or personal interview), by written feedback card, or through some other technique for communicating information.

The survey provider 120 is a computing system operated by an entity that provides surveying services related to customer satisfaction. In this particular embodiment, the survey provider 120 is operated separately from the business manager 105. However, in other embodiments, the survey provider 120 could be implemented as a part of the business manager 105.

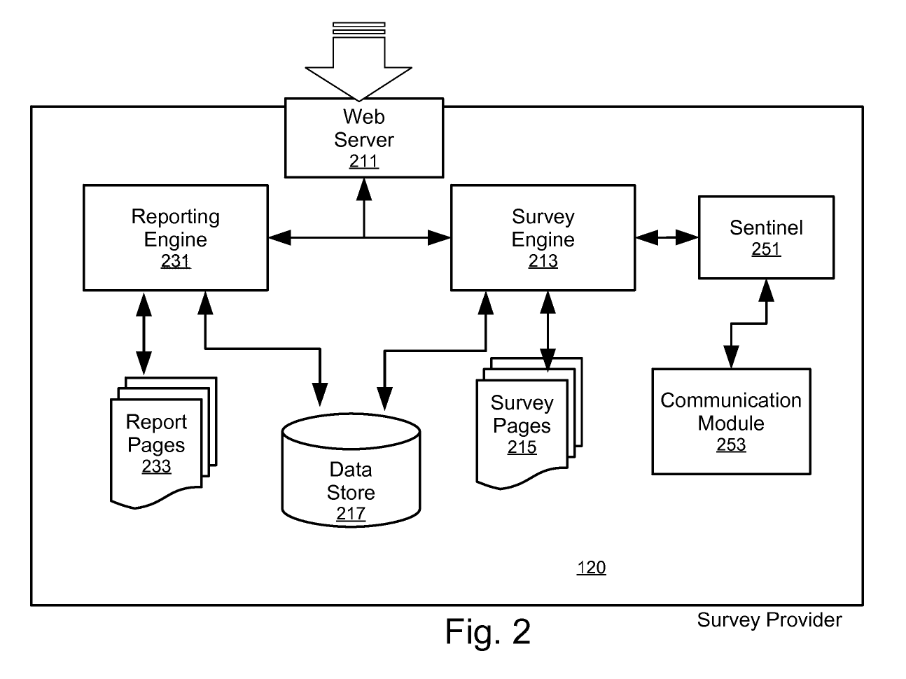

The survey provider 120 is coupled to the network 125 and allows visitors to participate in feedback surveys. As described in greater detail below in conjunction with FIG. 2, the survey provider 120 enables the customer 110 to answer several predetermined questions about the customer's experience. The survey provider 120 is configured to aggregate and make available the survey information to the business manager 105. For example, the survey provider 120 may expose a private login location that the business manager 105 may access to review the survey information. In addition, the survey provider 120 may be configured to monitor the feedback provided by customers in near-real time, and to transmit a notice of any critical information entered by the customer 110.

In operation, the system 100 enables the customer 110 to provide feedback about the customer's satisfaction with the business. The business manager 105 can review the feedback information online. In one example, the customer may have recently visited an establishment, such as a restaurant, operated by the business. The customer may be provided with information about participating in a satisfaction survey, and notified to contact the survey provider 120, such as over the Internet. Incentives could be made available for the customer's effort, although such is certainly not necessary.

If during the process of completing the survey, the customer 110 provides the survey provider 120 with critical or alarming information, a notice is immediately (or reasonably immediately) transmitted to the business manager 105. The critical information may be predefined by the business manager 105, such as key words of interest, phrases, common misspellings of words (collectively referred to generically as “key words”), as well as statistical indications of customer dissatisfaction. For example, a restaurant chain may have engaged the survey provider 120 to collect customer feedback information. The restaurant chain management may be highly concerned if any customer were to provide feedback that indicated its restaurants are unclean. Thus, if the customer 110 is a recent patron of one of the restaurant's locations, and provides feedback that includes certain key words, such as “filthy” or “dirty,” the survey provider 120 may transmit a notice 130 (e.g., an e-mail message, or the like) to the business manager 105 with that information. In this way, the business manager 105 can immediately follow up with the customer or pursue some remedial action to correct whatever problem exists. Often times when a business responds in haste to a customer's complaint, the customer may be impressed with the business's sincerity about customer satisfaction, thus ameliorating the negative opinion that the customer may have already formed.

FIG. 2 is a functional block diagram illustrating in greater detail the survey provider introduced in conjunction with FIG. 1. In this implementation, the survey provider 120 includes a web server component 211 that provides remote access to information stored at the survey provider 120. Web servers are known in the art and need not be described in greater detail. The web server component 211 may also couple other computing devices on the network 125 to other components of the survey provider 120.

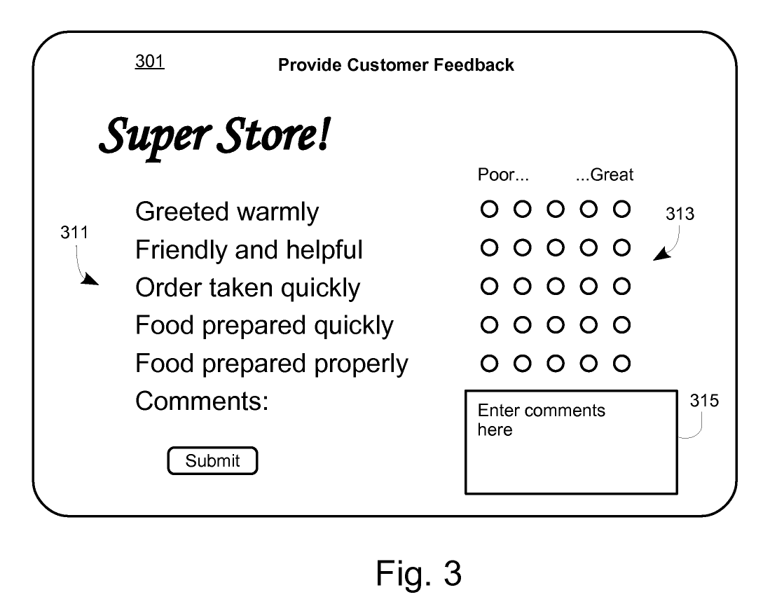

The web server 211 may interact with a survey engine component 213 to conduct the customer satisfaction survey. The survey engine 213 may serve up one or more survey pages 215, which include questions about customer satisfaction. For example, referring briefly to FIG. 3, a display 301 illustrates a sample screen that may be presented by the survey pages 215 when a customer accesses the survey provider 120. The display 301 may be styled to match the web presence of the business. In this particular implementation, the display 301 includes several questions 311 designed to determine the customer's experience during a visit. Commonly, the questions may be answered using selection buttons 313 that are each associated with a level of satisfaction ranging from very satisfied to very unsatisfied. Typically, the customer is also presented with an opportunity to provide comments of a more general nature. For example, the survey provider 120 may present the customer 110 with a text entry box 315 allowing the customer to type the customer's personal comments.

Returning now to FIG. 2, the survey engine 213 also interacts with a data store 217 to store the survey data collected using the survey pages 215. The survey data in the data store 217 is stored immediately so it is available to other components, such as the reporting engine 231, in real time or near real time. The reporting engine 231 is another component accessible via the web server 211 to other computers over the network 125.

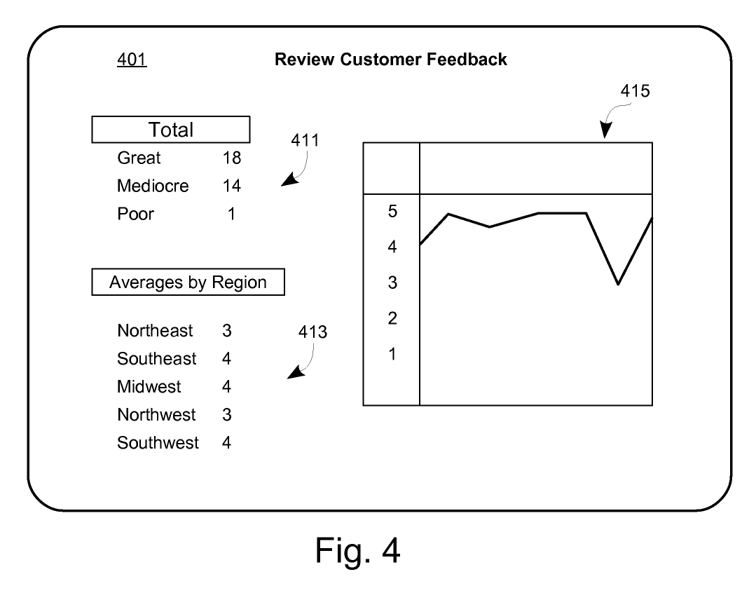

The reporting engine 231 enables designated parties to login and review the survey data stored in the data store 217. Upon successful login, the reporting engine 231 may present report pages 233 to the requesting party, such as the business manager 105. The report pages 233 format the survey data from the data store 217 in varying ways to provide the business manager 105 with a comprehensive and flexible mechanism for evaluating customer satisfaction. For example, referring briefly to FIG. 4, a display 401 may be presented to the business manager 105 that summarizes the survey data. A total area 411 may be used to summarize the survey data for each of several different locations or stores of the business. A regions area 413 identifies each of several different regions or sub areas that make up the total 411 enabling the business manager 105 to view a side-by-side comparison of each store being surveyed. Presenting this data in a simple, graphical matter simplifies the task of identifying areas where one store needs improvement compared to other related stores, this helping to improve those areas.

Several layers may be provided so that the business manager 105 can drill down from a national or regional level down to each individual store or property. Charting information 415 may also be presented to give a historical perspective of the change in customer satisfaction scores over time. Similarly, graphical charts can be used to present the frequency with which customers are expressing certain concepts by keyword categories over time.

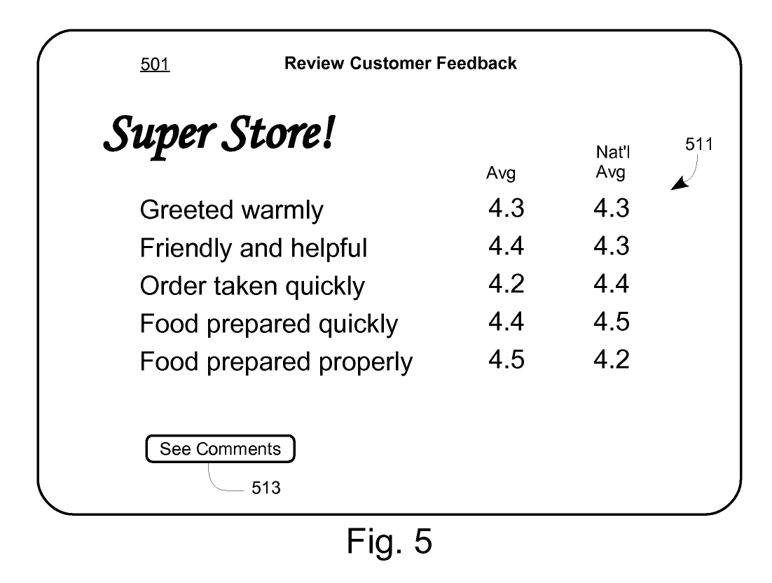

Turning briefly to FIG. 5, another display 501 may be used to present the business manager 105 with customer satisfaction scores 511 for each question presented in the survey. This information provides the business manager 105 with important feedback information that the business can use to improve its service. A comments button 513 can be provided to give access to the actual comments submitted by customers that participated in the survey. Key words in the comments can be color coded and categorized. For example, key words such as “cleanliness” could be displayed in red.

The system can be used to display the survey data in a graphical manner that makes the information easy to understand. For example, colored dots or icons can be used to illustrate scores above or below predetermined thresholds, such as red dots for problem areas, green dots for good scores, and yellow dots for mediocre scores. The graphical icons or dots provides an intuitive representation of the data. This system differs from existing technologies that generally provide survey data only as numbers in tables, which are hard to absorb and visualize.

Returning now to FIG. 2, the survey provider 120 also includes a sentinel component 251 which is configured to identify and act upon critical events. In one example, the sentinel 251 cooperates with the survey engine 213 to evaluate the survey data provided by the customer 110. If the sentinel 251 identifies any critical occurrences, a notice is generated of the occurrence. Examples of a critical occurrence include satisfaction scores below a certain threshold for one or more questions, an aggregate satisfaction score below a given threshold, and the existence of one or more key words that have been identified as being important to the business. In one specific example, the sentinel 251 may parse each of the comments submitted by the customer to identify any key words of interest. If any such key words are identified, the sentinel 251 generates the notice. In one implementation, the notice includes the comment information provided by the customer as well as contact information for contacting the customer.

The sentinel 251 may interact with a communication module 253 to transmit the notice to the business manager 105. In one example, the communication module 253 may be an e-mail transmission component for delivering e-mail messages, an instant messaging component for transmitting an instant message, a Short Messaging Service (SMS) component for delivering a wireless text message, or perhaps another message delivery mechanism for transmitting a recorded message.

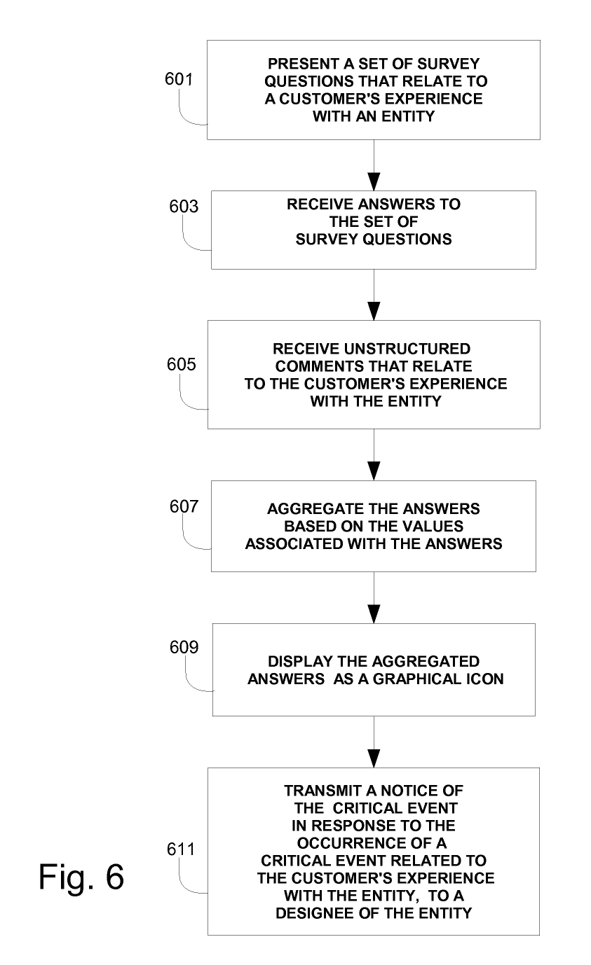

FIG. 6 is an operational flow diagram generally illustrating steps performed by a process 600 for measuring and/or reporting customer satisfaction. The process 600 begins at step 601, where an entity intends to determine the satisfaction level of its customers. The entity could be a business entity, a government agency, a non-profit organization, a school, or any other entity that is concerned with customer satisfaction.

At step 601, a set of survey questions is presented that relate to a customer's experience with an entity. Each survey question has a range of possible answers. The range extends from a lower extreme value to an upper extreme value.

At step 603, answers to the set of survey questions are received. Each answer is a value between the lower extreme value and the upper extreme value. In one example, each answer is a value from 1 to 5. Many other ranges are also possible.

At step 605, unstructured comments are received that relate to the customer's experience with the entity. For example, the customer may submit textual comments, such as by typing on a web page, or oral comments, such as over a telephone conversation or interview. Many other mechanisms are also possible for receiving comments from the customer.

At step 607, the answers are aggregated based on the values associated with the answers. For example if several customers participated in the survey, the answers for each of the questions from all the customers could be averaged.

At step 609, the aggregated answers are displayed as a graphical icon. The graphical icon could be displayed in a color based on a relationship between the aggregated answers and threshold values between the lower extreme value and the upper extreme value. Each threshold may correspond to a different visual characteristic, such as a different color.

At step 611, in response to the occurrence of a critical event related to the customer's experience with the entity, a notice of the critical event is transmitted to a designee of the entity. In one example, the notice may be an electronic message delivered by e-mail, SMS, instant messenger, or the like. Alternatively, the notice could be a telephone call or pre-recorded message. The notice may include an explanation of the critical event, such as particular key words that appeared in a customer's satisfaction survey.

Reference has been made throughout this specification to “one embodiment,” “an embodiment,” or “an example embodiment” meaning that a particular described feature, structure, or characteristic is included in at least one embodiment. However, such phrases may refer to more than just one embodiment. Likewise, the described features, structures, or characteristics may be combined in any suitable manner in one or more embodiments.

One skilled in the relevant art may recognize, however, that embodiments may be practiced without one or more of the specific details, or with other methods, resources, materials, etc. In other instances, well known structures, resources, or operations have not been shown or described in detail merely to avoid obscuring aspects of the embodiments.

While example embodiments and applications have been illustrated and described, it is to be understood that the invention is not limited to the precise configuration and resources described above. Various modifications, changes, and variations apparent to those skilled in the art may be made in the arrangement, operation, and details of the methods and systems disclosed herein without departing from the scope of the claimed invention

I claim:

1. A method for reporting customer satisfaction, comprising:
presenting a set of survey questions that relate to a customer's experience with an entity, each survey question having a range of possible answers, the range extending from a lower extreme value to an upper extreme value;
receiving answers to the set of survey questions, each answer being a value between the lower extreme value and the upper extreme value;
receiving unstructured comments that relate to the customer's experience with the entity;
aggregating the answers based on the values associated with the answers; and
displaying the aggregated answers as a graphical icon, the graphical icon being displayed in a color, the color being based on a relationship between the aggregated answers and threshold values between the lower extreme value and the upper extreme value, each threshold corresponding to a different visual characteristic.

2. The method recited in claim 1, wherein the entity comprises an enterprise having multiple locations.

3. The method recited in claim 2, wherein displaying the aggregated answers further comprises enabling a drill down of the aggregated answers, the drill down being based on a hierarchy of groupings of locations associated with the entity.

4. The method recited in claim 1, further comprising:
in response to the occurrence of a critical event related to the customer's experience with the entity, transmitting a notice of the critical event to a designee of the entity.

5. The method recited in claim 4, wherein the critical event comprises a key word being identified within the comments.

6. The method recited in claim 4, wherein transmitting the notice comprises issuing a message to the designee of the entity, the message including contact information for the customer.

7. The method recited in claim 4, wherein the critical event comprises receiving an answer having a value below a predetermined threshold.

8. A method for reporting customer satisfaction, comprising:
presenting a set of survey questions that relate to a customer's experience with an entity, each survey question having a range of possible answers, the range extending from a lower extreme value to an upper extreme value;
receiving answers to the set of survey questions, each answer being a value between the lower extreme value and the upper extreme value;
receiving unstructured comments that relate to the customer's experience with the entity; and
in response to the occurrence of a critical event related to the customer's experience with the entity, transmitting a notice of the critical event to a designee of the entity.

9. The method recited in claim 8, wherein the entity comprises an enterprise having multiple locations.

10. The method recited in claim 8, further comprising:
aggregating the answers based on the values associated with the answers; and
displaying the aggregated answers as a graphical icon, the graphical icon being displayed in a color, the color being based on a relationship between the aggregated answers and threshold values between the lower extreme value and the upper extreme value, each threshold corresponding to a different visual characteristic.

11. The method recited in claim 10, wherein displaying the aggregated answers further comprises enabling a drill down of the aggregated answers, the drill down being based on a hierarchy of groupings of locations associated with the entity.

12. The method recited in claim 8, wherein the critical event comprises a key word being identified within the comments.

13. The method recited in claim 8, wherein transmitting the notice comprises issuing a message to the designee of the entity, the message including contact information for the customer.

14. The method recited in claim 8, wherein the critical event comprises receiving an answer having a value below a predetermined threshold.

15. The method recited in claim 8, further comprising graphically representing a frequency of occurrence of the critical event.

16. The method recited in claim 15, wherein the frequency of occurrence of the critical event comprises the frequency with which customers use a key word in comments.

17. The method recited in claim 16, further comprising graphically representing a trend over time of the frequency with which customers use the key word.

18. A computer-readable medium having computer-executable components for reporting customer satisfaction, comprising:
a survey engine configured to present survey pages, the survey pages including survey questions about a customer's satisfaction with an entity, each survey question having a range of possible answers, the range extending from a lower extreme value to an upper extreme value, the survey engine being further configured to receive answers to the survey questions and textual comments;
a reporting engine configured to display the answers to the survey questions, the reporting engine being further configured to display the answers in a graphical manner using at least one icon, the icon having a characteristic based on values associated with the answers; and
a sentinel configured to receive an indication of a critical event from the survey engine, the critical event being related to the answers and/or the textual comments, the sentinel being further configured to transmit a notice of the critical event to a designee of the entity.
